(19) United States
(12) Patent Application Publication
(10) Pub. No.: US 2020/0187223 A1
(43) Pub. Date: Jun. 11, 2020

(54) CELL GROUP OPTIMIZATION BY MEANS OF PROBING

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Ljupco Jorguseski, Rijswijk (NL); Remco Litjens, Voorschoten (NL); Konstantinos Trichias, Athens (GR); Haibin Zhang, Voorburg (NL)

(21) Appl. No.: 16/472,820

(22) PCT Filed: Dec. 22, 2017
(86) PCT No.: PCT/EP2017/084330

§ 371 Date: Oct. 2, 2019

(30) Foreign Application Priority Data
Dec. 29, 2016 (EP) 16207281.3

(51) Int. Cl. H04W 72/12; H04W 24/04; H04W 88/02; H04W 92/10

(52) U.S. Cl. CPC H04W 72/1231; H04W 24/04; H04W 92/10; H04W 88/023; H04W 72/1236

(57) ABSTRACT

A system (1) is configured to associate each of multiple sets of cell groups to at least one of multiple successive time periods and for each successive time period, associate each of multiple mobile devices (11-15) to one cell group of the set associated with the time period. The system is further configured to arrange transmission of one or more messages to the mobile devices, the messages instructing each mobile device to participate during each of the successive time periods in a cell group and control multiple base stations (21-25) to form, during each of the successive time periods, the cell groups. The system is also configured to determine and/or receive sets of performance indicator values relating to actual transmissions between the mobile devices and the base stations during the successive time periods, and select one set of the sets of cell groups based on the performance indicator values.

### FIELD OF THE INVENTION

The invention relates to a system for determining cell groups in a mobile communication network and a device for participating in a cell group.

The invention further relates to a method of determining cell groups in a mobile communication network and a method of participating in a cell group.

The invention also relates to a computer program product enabling a computer system to perform any of such methods.

### BACKGROUND OF THE INVENTION

In order to increase the experienced bit rates of a mobile device by means of reducing its experienced interference and better utilizing the network wide available spectrum resources, such a single mobile device may be served by multiple cells from one or more base stations simultaneously. In LTE Coordinated MultiPoint (CoMP) transmission, operation of the multiple cells is coordinated so that network performance at the cell edges is improved. One possible coordination among the multiple cells from the same or different base stations is to create a virtual cell. The virtual cell may be used to cover a hot spot of traffic (i.e. an area with a high concentration of mobile devices), for example. In CoMP, the network and the mobile devices are normally able to distinguish the multiple cells that are coordinated to serve the mobile devices as logically separated cells. When using virtual cells, the network and the mobile devices are normally not able to distinguish the cells cooperatively serving the mobile devices, i.e. they operate as logically one cell (and hence the term virtual cell).

A network administrator might be able to configure statically which cells and base stations cooperate, e.g. in a CoMP group or virtual cell, but this does not result in optimal resource usage. US 2012/0135766 A1 discloses a method for adaptive cell clustering. Measurement information is received from a plurality of cells. Each cell provides signal measurements based on the feedback of the devices they serve. Cell clusters are determined based on this measurement information and the cells are informed of the determined cell clusters, that they currently belong to.

A drawback of the method disclosed in US2012/0135766 is that the signal measurements performed by the mobile devices do not allow for an accurate estimation of the mobile device's actual performance, and consequently cell group and network performance, under a network configuration with the selected cell groups (clusters). This results in selection of cell groups which lead to suboptimal mobile device, cell group and/or network performance.

### SUMMARY OF THE INVENTION

It is a first object of the invention to provide a system for determining cell groups in a mobile communication network, which helps achieve an improvement of performance.

It is a second object of the invention to provide a device for participating in a cell group, which allows cell groups to be determined that lead to an improvement of performance.

It is a third object of the invention to provide a method of determining cell groups in a mobile communication network, which helps achieve an improvement of performance.

It is a fourth object of the invention to provide a method of participating in a cell group, which allows cell groups to be determined that lead to an improvement of performance.

According to the invention, the first object is realized in that the system for determining cell groups in a mobile communication network comprises at least one processor configured to determine a plurality of sets of cell groups, each set comprising a plurality of cell groups, each of said cell groups comprising at least one cell, and at least one of said cell groups of each set comprising a plurality of cells, associate each set of said plurality of sets of cell groups to at least one of a plurality of successive time periods, for each of said plurality of successive time periods, associate each of a plurality of mobile devices to one cell group of said set associated with said time period, arrange transmission of one or more messages to said plurality of mobile devices, said one or more messages instructing each mobile device to participate during each of said plurality of successive time periods in a cell group associated with said each mobile device in connection with said time period, control a plurality of base stations associated with cells of said plurality of sets of cell groups to form, during each of said plurality of successive time periods, said cell groups of said set of cell groups associated with said time period, determine and/or receive a plurality of sets of (e.g. mobile device specific, cell group specific and/or network specific) performance indicator values relating to actual transmissions between said plurality of mobile devices and said plurality of base stations during said plurality of successive time periods, each set of said plurality of sets of performance indicator values relating to a different one of said plurality of successive time periods, and select one set of said plurality of sets of cell groups based on said determined plurality of sets of performance indicator values.

The system may be a component of the mobile communication network. The system may be a base station or a stand-alone network component, for example. If the system is a base station, controlling the base stations to form the cell groups of a set of cell groups may comprise configuring the base station in accordance with the cell groups of the set of cell groups and transmitting messages to other base stations corresponding to the cells in the cell groups instructing them to form the cell groups of the set of cell groups. The cell groups of a set are preferably disjoint, but alternatively, one or more cells may be part of multiple cell groups. The plurality of sets of cell groups may be determined offline (i.e. before the cell grouping process starts), e.g. with a tool which decides based on historic data where and how to create the cell groups, or online (i.e. as part of the cell grouping process), e.g. based on initial feedback from the mobile devices. Typically, a single base station serves mobile devices via multiple, e.g. three, cells. Preferably, each set of cell groups comprises the same cells.

The inventors have recognized that determining cell groups based on performance indicator values relating to actual transmissions between the mobile devices and the base stations (also referred to as “probing” in this specification) helps achieve a better performance. The performance indicator values may indicate mobile device performance, network performance and/or cell group performance, for example. Cell group performance may be an aggregation of the mobile devices' experienced performance when served by a cell group, for example. In certain situations, a more optimal mobile device performance may be preferred over a more optimal cell group or network performance, e.g. for mobile devices used by priority users like police or fire department. The set of cell groups that is selected may be the one with the lowest average delay or the highest throughput, for example.

Said at least one processor may be configured to arrange transmission of one or more further messages to said plurality of mobile devices, said further messages instructing said mobile devices to participate in a cell group of said selected set of said plurality of sets of cell groups, and control said base stations to form said cell groups of said selected set of said plurality of sets of cell groups. After the probing phase has ended, the selected set of cell groups is thus put into effect and intended to be used for a longer period of time, e.g. until the performance of the network, one or more of the cell groups, and/or one or more of the mobile devices starts to degrade.

Said at least one processor may be configured to receive at least some performance indicator values of said plurality of sets of performance indicator values from said plurality of mobile devices. Alternatively or additionally, said at least one processor may be configured to determine at least some performance indicator values of the plurality of sets of performance indicator values in the mobile communication network, e.g. in the system and/or in one or more of the base stations. The mobile devices and the mobile communication network may determine the performance indicator values cooperatively, for example.

Said plurality of sets of performance indicator values may comprise, but is not limited to, one or more performance indicator values representing at least one of throughput, delay and error rate. Alternatively or additionally, the plurality of sets of performance indicator values may comprise one or more performance indicator values representing call success rate, call drop rate, SINR, interference level, energy consumption, spectral resource efficiency, cost per bit and/or one or more other types of performance indicators, for example.

At least two of said plurality of successive time periods may be associated with the same set of said plurality of sets of cell groups. By alternately probing different sets of cell groups, the effects of one or more types of channel variation, which may be caused by, for example, fast fading, slow fading, multipath fading, and shadow fading, may be compensated. Since the channel is not always the same (it varies over time), it is advantageous to compensate for this by trying not to measure one cell group during a channel deep and another cell group during a channel peak. The effects may be effects on the short term timescale (in the order of milliseconds or even microseconds), called fast fading, and/or on a longer timescale. Fast fading consists of rapid random variations of the communication channel quality, which can affect the quality of the transmission. As a result, if a transmitted bit happens to encounter a fade deep of the channel, it may not be delivered properly. On a longer timescale, the impact of incidental environmental factors, e.g. weather conditions or passing vehicles, on the performance indicator values may be reduced, for example.

According to the invention, the second object is realized in that the device for participating in a cell group comprises a communication interface and at least one processor configured to use said communication interface to receive one or more messages from a mobile communication network, said one or more messages instructing said mobile device to participate during each of a plurality of successive time periods in a cell group associated with said time period, and configured to perform said instructed participation. The device may be a mobile device or a base station, for example.

Said at least one processor may be configured to determine a plurality of sets of (e.g. mobile device specific, cell group specific and/or network specific) performance indicator values relating to actual transmissions between at least one mobile device and said mobile communication network during said plurality of successive time periods, each set of said plurality of sets of performance indicator values relating to a different one of said plurality of successive time periods, and to use said communication interface to transmit said plurality of sets of performance indicator values to said mobile communication network. Performance indicator values of the same type may then be compared by the mobile communication network.

Said plurality of sets of performance indicator values may comprise one or more performance indicator values representing at least one of throughput, delay and error rate.

According to the invention, the third object is realized in that the method of determining cell groups in a mobile communication network comprises determining a plurality of sets of cell groups, each set comprising a plurality of cell groups, each of said cell groups comprising at least one cell, and at least one of said cell groups of each set comprising a plurality of cells, associating each set of said plurality of sets of cell groups to at least one of a plurality of successive time periods, for each of said plurality of successive time periods, associating each of a plurality of mobile devices to one cell group of said set associated with said time period, arranging transmission of one or more messages to said plurality of mobile devices, said one or more messages instructing each mobile device to participate during each of said plurality of successive time periods in a cell group associated with said each mobile device in connection with said time period, controlling a plurality of base stations associated with cells of said plurality of sets of cell groups to form, during each of said plurality of successive time periods, said cell groups of said set of cell groups associated with said time period; determining and/or receiving a plurality of sets of (e.g. mobile device specific, cell group specific and/or network specific) performance indicator values relating to actual transmissions between said plurality of mobile devices and said plurality of base stations during said plurality of successive time periods, each set of said plurality of sets of performance indicator values relating to a different one of said plurality of successive time periods, and selecting one set of said plurality of sets of cell groups based on said determined plurality of sets of performance indicator values.

According to the invention, the fourth object is realized in that the method of participating in a cell group comprises receiving one or more messages from a mobile communication network at a device, said one or more messages instructing said device to participate during each of a plurality of successive time periods in a cell group associated with said time period, and performing said instructed participation at said device.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations comprising: determining a plurality of sets of cell groups, each set comprising a plurality of cell groups, each of said cell groups comprising at least one cell, and at least one of said cell groups of each set comprising a plurality of cells, associating each set of said plurality of sets of cell groups to at least one of a plurality of successive time periods, for each of said plurality of successive time periods, associating each of a plurality of mobile devices to one cell group of said set associated with said time period, arranging transmission of one or more messages to said plurality of mobile devices, said one or more messages instructing each mobile device to participate during each of said plurality of successive time periods in a cell group associated with said each mobile device in connection with said time period, controlling a plurality of base stations associated with cells of said plurality of sets of cell groups to form, during each of said plurality of successive time periods, said cell groups of said set of cell groups associated with said time period; determining and/or receiving a plurality of sets of (e.g. mobile device specific, cell group specific and/or network specific) performance indicator values relating to actual transmissions between said plurality of mobile devices and said plurality of base stations during said plurality of successive time periods, each set of said plurality of sets of performance indicator values relating to a different one of said plurality of successive time periods, and selecting one set of said plurality of sets of cell groups based on said plurality of sets of performance indicator values.

The same or a different non-transitory computer-readable storage medium stores at least one further software code portion, the further software code portion, when executed or processed by a computer, being configured to perform executable operations comprising: receiving one or more messages from a mobile communication network at a device, said one or more messages instructing said device to participate during each of a plurality of successive time periods in a cell group associated with said time period, and performing said instructed participation at said device.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of an embodiment of the system and device of the invention;

FIG. 2 depicts a first set of cell groups involving the system and devices of FIG. 1;

FIG. 3 depicts a second set of cell groups involving the system and devices of FIG. 1;

FIG. 4 is a flow diagram of a first embodiment of the methods of the invention;

FIG. 5 is a flow diagram of a second embodiment of the methods of the invention;

FIG. 6 is a block diagram of an exemplary cellular telecommunication system used in an embodiment of the device and the system of the invention; and

FIG. 7 is a block diagram of an exemplary data processing system for performing the methods of the invention.

Corresponding elements in the drawings are denoted by the same reference numeral.

### DETAILED DESCRIPTION OF THE DRAWINGS

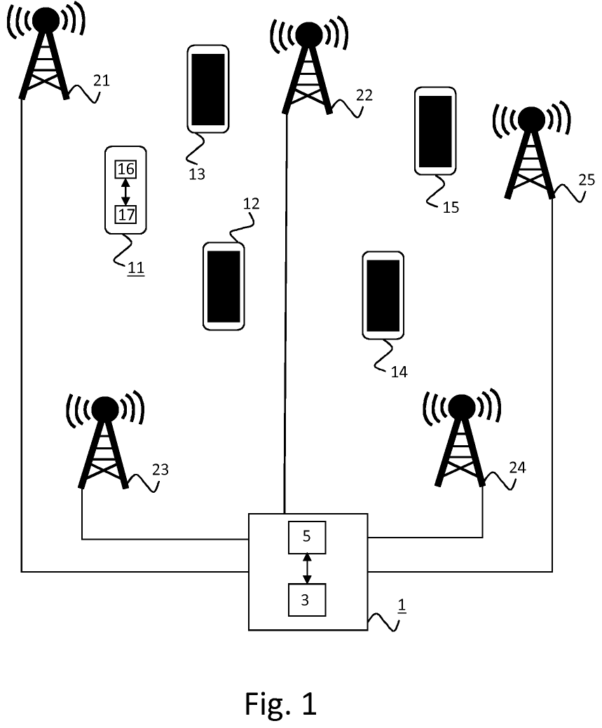

FIG. 1 shows a system 1, mobile devices 11 to 15 and base stations 21 to 25. The system 1 comprises a processor 3. The processor 3 is configured to determine a plurality of sets of cell groups. Each set comprises a plurality of cell groups and each of the cell groups comprises at least one cell. At least one of the cell groups of each set comprises a plurality of cells. The processor 3 is further configured to associate each set of the plurality of sets of cell groups to at least one of a plurality of successive time periods and for each of the plurality of successive time periods, associate each of a plurality of mobile devices to one cell group of the set associated with the time period. The processor 3 is also configured to arrange transmission of one or more messages to the plurality of mobile devices. The one or more messages instruct a mobile device to participate during each of the plurality of successive time periods in a cell group associated with each mobile device in connection with the time period.

The processor 3 is further configured to control a plurality of base stations associated with cells of the plurality of sets of cell groups to form, during each of the plurality of successive time periods, the cell groups of the set of cell groups associated with the time period. The processor 3 is also configured to determine and/or receive a plurality of sets of performance indicator values relating to actual transmissions between the plurality of mobile devices and the plurality of base stations during the plurality of successive time periods. Each set of the plurality of sets of performance indicator values relates to a different one of the plurality of successive time periods. The processor 3 is further configured to select one set of the plurality of sets of cell groups based on the determined plurality of sets of performance indicator values.

The mobile device 11 comprises a communication interface 16 and a processor 17. The processor 17 is configured to use the communication interface 16 to receive one or more messages from a mobile communication network, the one or more messages instructing the device to participate during each of a plurality of successive time periods in a cell group associated with the time period, and configured to perform the instructed participation. The mobile devices 12 to 15 and the base stations 21 to 25 comprise a communication interface and a processor configured as described above, but these components are not shown in FIG. 1.

The processor 3 of the system 1 is also configured to arrange transmission of one or more further messages to the plurality of mobile devices. The further messages instruct the mobile devices to participate in a cell group of the selected set of the plurality of sets of cell groups. The processor 3 of the system 1 is further configured to control the base stations to form the cell groups of the selected set of the plurality of sets of cell groups.

The processor 17 of the mobile device 11 may be configured to determine a plurality of sets of performance indicator values relating to actual transmissions between at least one mobile device and the mobile communication network during the plurality of successive time periods. Each set of the plurality of sets of performance indicator values relate to a different one of the plurality of successive time periods. The processor 17 of the mobile device 11 may be further configured to use the communication interface 16 to transmit the plurality of sets of performance indicator values to the mobile communication network. The processor 3 of the system 1 may be configured to receive the plurality of sets of performance indicator values from the mobile device 11. The system 1 may further receive sets of performance indicator values from one or more of the mobile devices 12 to 15 and the base stations 21 to 25. The sets of performance indicator values may comprise one or more performance indicator values representing at least one of throughput, delay and error rate, for example. Other types of performance indicator values may alternatively or additionally be used.

A mobile device may also be referred to by those skilled in the art as a mobile station (MS), a subscriber station, a mobile unit, a subscriber unit, a wireless unit, a wireless terminal, a wireless device, a wireless communications device, a remote device, a mobile subscriber station, an access terminal (AT), a mobile terminal, a user equipment (UE), a remote terminal, a handset, a terminal, a user agent, a mobile client, a client, or some other suitable terminology. Examples of a wireless terminal include a cellular phone, a smart phone, a session initiation protocol (SIP) phone, a laptop, a notebook, a netbook, a smartbook, a personal digital assistant (PDA), a tablet computer, a satellite radio, a global positioning system (GPS) device, a multimedia device, a video device, a digital audio player, a camera, a game console, or any other similar functioning device. A mobile device may have a slot for a UICC (also called a SIM card) or be provisioned with an embedded or enhanced version thereof for storage of credentials, for example. The base stations 21 to 25 may comprise, one or more LTE eNodeBs, for example.

In the embodiment shown in FIG. 1, the mobile device 11 comprises one processor 17. In an alternative embodiment, the mobile device 11 comprises multiple processors. In the embodiment shown in FIG. 1, the system 1 comprises one processor 3. In an alternative embodiment, the system 1 comprises multiple processors.

The communication interface 16 of the mobile device 11 may use WiFi, Ethernet or one or more cellular communication technologies such as GPRS, CDMA, UMTS and/or LTE to communicate with a base station, for example. The processor 17 may be a general-purpose processor, e.g. an ARM or a Qualcomm processor, or an application-specific processor. The processor 17 may be an Android or iOS operating system, for example. The mobile device 11 may comprise storage means (not shown), e.g. solid state memory. The mobile device 11 may comprise other components typical for a mobile device, e.g. a random access memory and a battery.

The processor 3 of the system 1 may be a general-purpose processor, e.g. an Intel or an AMD processor, or an application-specific processor, for example. The processor 3 may comprise multiple cores, for example. The processor 3 may run a Unix-based or Windows operating system, for example. The system 1 may comprise other components typical for a component in a mobile communication network, e.g. a power supply and a random access memory. The system 1 may comprise storage means (not shown). The storage means may comprise solid state memory, e.g. one or more Solid State Disks (SSDs) made out of Flash memory, or one or more hard disks, for example.

The communication interface 5 of the system 1 may be connected to the base stations 21 to 25 via a wired connection, for example. In the embodiment shown in FIG. 1, the system 1 is a single, stand-alone device. In another embodiment, the system 1 may comprise multiple devices and/or may be combined with another function in a mobile communication network, e.g. a base station. In another embodiment, the system 1 may comprise multiple base stations distributed over multiple sites, for example.

The operation of the system 1, mobile devices 11 to 15 and base stations 21 to 25 is explained with the help of an example. For the sake of this example, it is assumed that the five mobile devices 11 to 15 report the measured cells as is shown in Table 1 below. In this example, each cell corresponds to a single base station. Each mobile device reports back to the network which cells it can “hear” based on initial Reference Signal Received Power (RSRP) measurements. If a cell is “heard” by a mobile device with a RSRP which exceeds a certain threshold, then it is reported in its list.

TABLE 1

| Mobile Device | Reported Cells |
|---|---|
| 11 | 21, 22, 23 |
| 12 | 21, 22, 23 |
| 13 | 21, 22 |
| 14 | 22, 23, 24, 25 |
| 15 | 22, 25 |

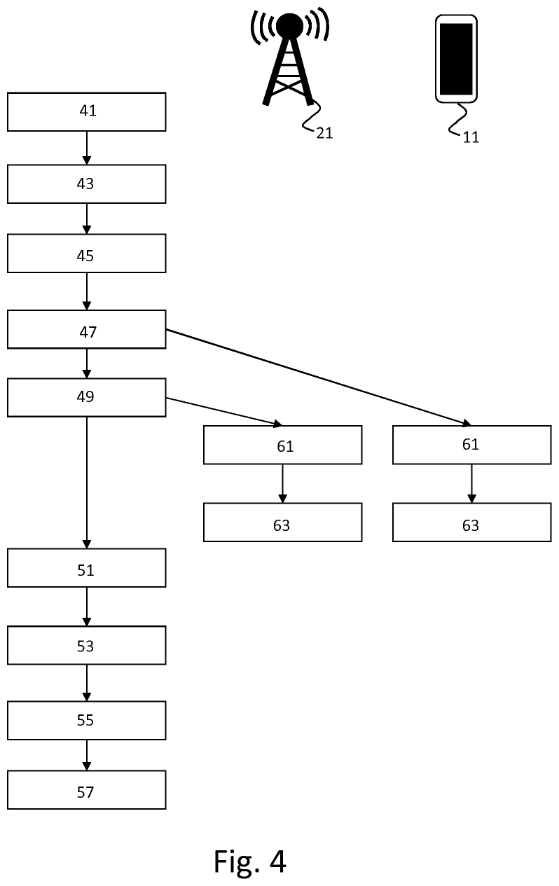

A flow diagram of a first embodiment of the methods of the invention is shown in FIG. 4. A step 41 comprises the system 1 determining a plurality of sets of cell groups. Each set comprises a plurality of cell groups and each of the cell groups comprises at least one cell. At least one of the cell groups of each set comprises a plurality of cells.

When applied to the afore-mentioned example, the method involves the system 1 determining how to group cells/base stations 21 to 25 for the mobile devices 11 to 15. The system 1 first determines a plurality of candidate sets of cell groups. The plurality of candidate sets of cell groups may be determined offline (i.e. before the cell grouping process starts), e.g. with a tool which decides based on historic data where and how to create the cell groups, or online (as part of the cell grouping process), e.g. based on initial feedback from the mobile devices. For example, the plurality of sets of cell groups may be determined online using the teachings of US2012/0135766. A candidate set of cell groups may include one or more cell groups comprising just a single macro-cell, which may create a virtual cell or not.

A candidate set of cell groups may comprise disjoint cell groups or at least some of the cell groups may overlap:

Disjoint cell-groups: There is no one cell in the candidate set that participates in more than one cell group of the candidate set at the same time. For example, for the cells/base stations 21 to 25 of FIG. 1, two possible cell-groups that could be generated in this way are, for example, cell-group {21,22,23} and cell-group {24,25}.

Overlapping cell-groups: There are cells in the candidate set that participate in the formation of more than one cell groups of the candidate set and serve one or more mobile devices in all of the cell groups in which they participate. This allows more flexibility in the formation of cell groups, but may increase scheduling complexity. For example, for the cells/base stations 21 to 25 of FIG. 1, two possible cell-groups that could be generated in this way are, for example, cell-group {21,22,23} and cell-group {22,24,25}. In this case cell/base station 22 participates and serves users in both cell-groups.

Each of the candidate sets of cell groups may comprise only disjoint cell groups, each of the candidate sets of cell groups may comprise at least some overlapping cell groups, or some of the candidate sets of cell groups may comprise only disjoint cell groups and others candidate sets of cell groups may comprise at least some overlapping cell groups. Furthermore, all cells in a cell group may serve all of the mobile devices in the cell group or one or more of the mobile devices in a cell group may be served by a subset of the cells in a cell group:

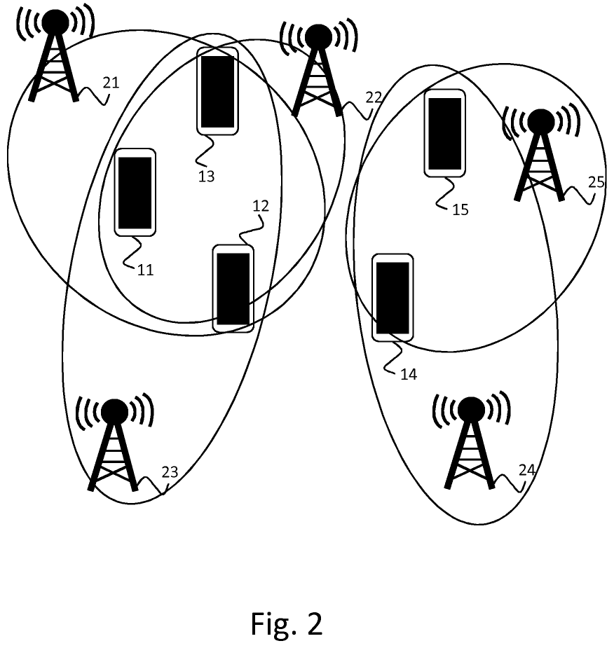

All cells in the cell group serve all of the UEs in the cell group: If this option is used, then cell groups have to be created in such sizes and configurations that all the participating cells in a cell group actively serve all the mobile devices belonging to that cell group. In the example of FIG. 2, in cell group {21, 22, 23} all three cells/base stations 21, 22 and 23 actively serve all mobile devices in that group, i.e. mobile devices 11, 12 and 13, and in cell group {24, 25} both cells/base stations 24 and 25 serve both mobile devices 14 and 15.

UEs in a cell group may be served by a subset of the cells of the cell group: If this option is used, then the definition of a cell group is more relaxed in the sense that not all cells participating in a cell group have to serve all mobile devices belonging to that cell group. Each mobile device belonging to such a cell group may be served by a subset of the cells that form that cell group. In the example of FIG. 2, in cell group {21, 22, 23}, mobile devices 11 and 12 may be served by all three cells/base stations (21, 22 and 23) while mobile device 13 may be served by only cells/base stations 21 and 22 (base station 23 may not serve mobile device 13, because the distance between them may be considered too large or there may be other causes that could render the transmission sub-optimal).

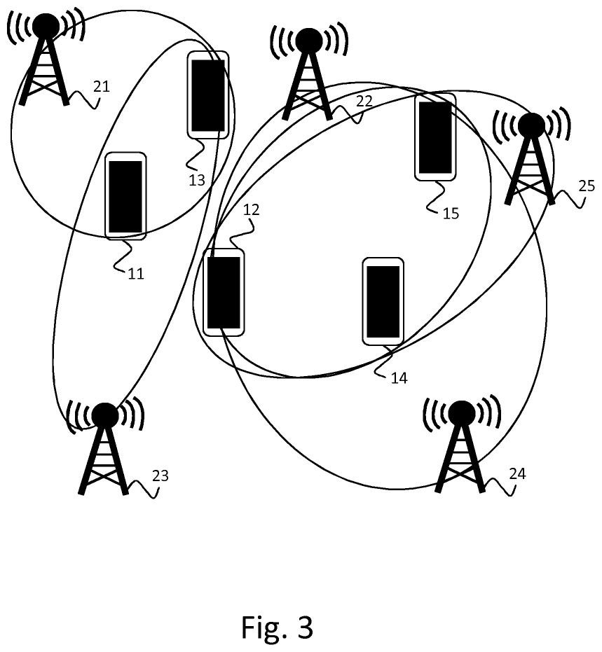

A step 43, see FIG. 4, comprises the system 1 associating each set of the plurality of sets of cell groups to at least one of a plurality of successive time periods. For example, the set of cell groups depicted in FIG. 2 may be associated with time period 1, e.g. 12:15:00-12:15:01, and the set of cell groups depicted in FIG. 3 may be associated with time period 2, e.g. 12:15:01-12:15:02.

A step 45 comprises the system for each of the plurality of successive time periods, associating each of a plurality of mobile devices to one cell group of the set associated with the time period. The mobile device assignment to the various candidate cell groups might happen in two different ways:

Implicitly decided during cell group selection: In this option, the assignment of the mobile devices to the cell groups is decided when determining the candidate sets of cell groups, so steps 41 and 43 are combined and performed at the same time. For example, the selected candidate sets of cell groups may be the ones that the network estimates are the best candidates based on a theoretical analysis which includes ‘light’ initial key performance indicator (KPI) values that were provided as feedback by the mobile devices (e.g. RSRP). In order for the system to make such a theoretical analysis, it may need to assume that the mobile devices are assigned to specific cells, in order to calculate the KPI values per cell-group. For instance, if the KPI based on which the selection was made was the maximization of the users RSRP in a cell group, the network would have to assume a certain assignment of mobile devices to cells (e.g. mobile devices are assigned to the cell to which they experience the highest RSRP) in order to estimate the cumulative RSRP within that cell group. In this case, the implicit assignment that the network makes during the selection phase of the cell group candidate sets continues to be used in the next steps of the process. This is the preferred option.

Decided independently of the cell group selection: In the case that the network has somehow decided on the set of cell groups to be probed without making any assumptions of the assignment of mobile devices to these cell groups (e.g. based on historical/topological data) then the assignment of mobile devices can be determined based on the calculation or estimation of KPIs after the system 1 has determined the plurality of candidate sets of cell groups (step 43 is performed after step 41). A few examples are mentioned below. These examples are not meant to be limiting. There are many other criteria that could be used, following the same logic.
Assignment based on maximum RSRP: Assign each mobile device to the cell group which contains the cell towards which the mobile device experiences the largest RSRP. In the case of Table 1 and FIG. 2 for instance, mobile device 11 and 12 would be assigned to cell group {21, 22, 23} since they both experience their strongest RSRP towards cell/base station 21.
Assignment based on maximum average RSRP: Assign each mobile device to the cell group that provides that mobile device with the maximum average RSRP, where the average RSRP is calculated over all the cells belonging to each cell group. In the case of FIG. 2 for instance, the average RSRP of all mobile devices would be calculated for cell groups {21, 22, 23} and {24, 25} and each mobile device would be assigned to the cell group that provided it with the strongest average RSRP.
Assignment based on estimated maximum throughput: Assign each mobile device to the cell group that will result in the mobile device experiencing maximum throughput. The network could make estimations (based on the initially reported feedback of each mobile device) about what kind of performance (in terms of throughput) each mobile device will experience in the different probed cell groups, and assign the mobile devices to the cell groups that maximize each mobile device's throughput.

A step 47, see FIG. 4, comprises the system 1 arranging transmission of one or more messages to the plurality of mobile devices. The one or more messages instruct each mobile device to participate during each of the plurality of successive time periods in a cell group associated with the each mobile device in connection with the time period. The one or more messages may also inform the mobile devices which frequency resources they should use.

Thus, the cell groups and the corresponding mobile device assignments are signaled to the mobile devices, and the mobile devices are informed on which time scale/how the cells will alternate between the different candidate sets of cell groups. Multiple probing approaches are possible, e.g. cyclically alternating between the different candidate sets of cell groups on a per Transmission Time Interval (TTI), e.g. TTI duration in LTE is 1 ms, or per ‘N TTIs’ basis, or successively applying a single longer probing period per candidate set of cell groups, or a hybrid form of these approaches. The selected approach, timescale and duration may be adaptively determined considering the level of accuracy needed and acquired in the assessment.

Preferably, a new type of control message is standardized with which the mobile devices participating in the probing may be informed about the configuration of the probing in a unicast or multicast way. That means that either each mobile device individually (unicast) or multiple mobile devices that all participate in the probing (multicast) would be informed through this newly standardized signal about the configuration of the upcoming probing with information such as the start, end and duration of the probing process, which cell group they will belong too and for how long, and when the switch between the probed groups is scheduled, for example. Once this information has been transmitted to the mobile devices, then the probing is ready to begin. Within each probing period and for each cell group, the mobile devices belonging to that cell group are assigned (time and frequency) resources (Physical Resource Blocks) as normal. The new type of control message may be transmitted on a newly standardized channel or on an existing channel, e.g. an LTE Physical Downlink Control Channel (PDCCH).

Alternatively, the System Information Blocks (SIBs) defined in the LTE standard may be used, for example. SIB1, which is transmitted once every 80 milliseconds, may be used, for example. In case the desired time scale of varying between probed candidate sets of cell groups matches the 80 milliseconds timescale of the SIB broadcasts, then no change to the standard would be needed, and in subsequent SIBs the candidate sets of cell groups applied in the upcoming inter-SIB period is signaled.

A step 49 comprises the system 1 controlling a plurality of base stations associated with cells of the plurality of sets of cell groups to form, during each of the plurality of successive time periods, the cell groups of the set of cell groups associated with the time period. Step 49 may involve transmitting one or more messages to one or more of the base stations.

A step 61 comprises a device, e.g. a mobile device or a base station, receiving one or more messages from the mobile communication network. The one or more messages instruct the device to participate during each of a plurality of successive time periods in a cell group associated with the time period. If the device is a mobile device, it receives the one or more message via one of the base stations. If the device is a base station, it receives the one or more messages from the system. A step 63 comprises the device performing the instructed participation. In the embodiment FIG. 4, steps 61 and 63 are performed by one or more mobile devices as well as one or more base stations.

A step 51 comprises the system determining and/or receiving a plurality of sets of performance indicator values relating to actual transmissions between the plurality of mobile devices and the plurality of base stations during the plurality of successive time periods (i.e. during the probing phase). Each set of the plurality of sets of performance indicator values relates to a different one of the plurality of successive time periods. In this embodiment, the system determines the plurality of sets of performance indicator values without receiving any performance indicator values from mobile devices or base stations. Even if a mobile device does not transmit or receive user data, it will generate transmit and receive control data, e.g. mobile device feedback (such as CQI, RSRP, PMI and RI) to aid decisions of scheduling and transmission parameters.

A step 53 comprises the system selecting one set of the plurality of sets of cell groups based on the plurality of sets of performance indicators. After the probing phase and based on the monitored performance (e.g. user throughput, delay, BLER) of the actual transmissions that took place during this probing phase, the system 1 decides which of the candidate sets of cell groups may be selected as optimal.

A step 55 comprises the system arranging transmission of one or more further messages to the plurality of mobile devices. The further messages instruct the mobile devices to participate in a cell group of the selected set of the plurality of sets of cell groups. A step 57 comprises the system controlling the base stations to form the cell groups of the selected set of the plurality of sets of cell groups. The candidate set that the system 1 decided to be optimal is thus used (by the mobile devices 11 to 15 and base stations 21 to 25) from that moment onwards.

As an alternative to probing each candidate set once, at least two of the plurality of successive time periods may be associated with the same (candidate) set of the plurality of sets of cell groups. An example of such an association is shown in Table 2. In Table 2, the candidate set shown in FIG. 2 (CS-I) is probed in time periods 1 and 3 and the candidate set shown in FIG. 3 (CS-II) is probed in time periods 2 and 4.

TABLE 2

| Period 1: CS-I | Period 2: CS-II | Period 3: CS-I | Period 4: CS-II |
|---|---|---|---|
| {21, 22, 23} | {21, 23} | {21, 22, 23} | {21, 23} |
| serve {11, 12, 13} | serve {11, 13} | serve {11, 12, 13} | serve {11, 13} |
| {24, 25} | {22, 24, 25} | {24, 25} | {22, 24, 25} |
| serve {14, 15} | serve {12, 14, 15} | serve {14, 15} | serve {12, 14, 15} |

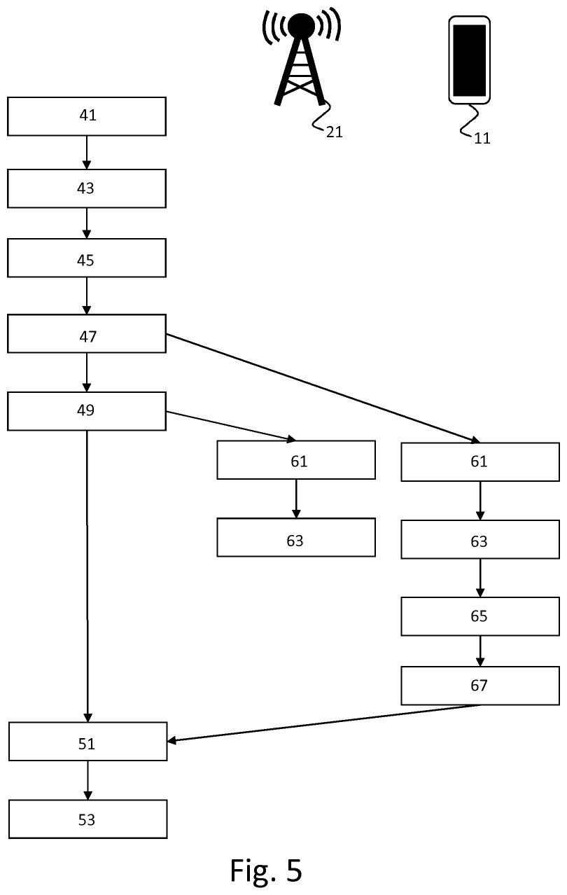

In the second embodiment of the methods of the invention is shown in FIG. 5, the methods comprise steps 65 and 67 instead of steps 55 and 57. Step 65 comprises the mobile device(s) determining a plurality of sets of performance indicator values relating to actual transmissions between at least one mobile device and the mobile communication network during the plurality of successive time periods. Each set of the plurality of sets of performance indicator values relates to a different one of the plurality of successive time periods. Step 67 comprises the mobile device(s) transmitting the plurality of sets of performance indicator values to the mobile communication network, e.g. to the system 1 via a base station. The sets of performance indicator values determined and transmitted by the mobile device may comprise one or more performance indicator values representing at least one of throughput, delay and error rate, for example.

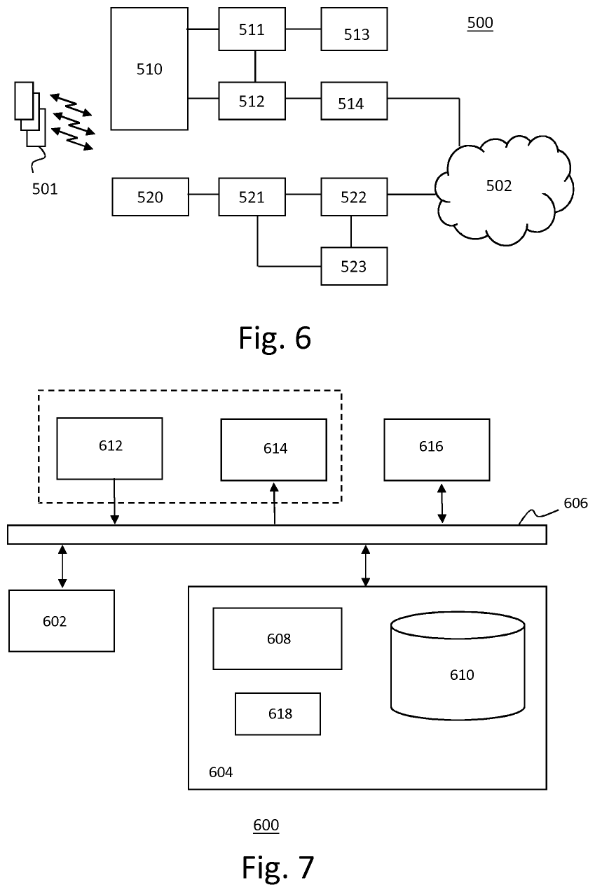

In the telecommunications system 500 of FIG. 6, three generations of networks are schematically depicted together for purposes of brevity. A more detailed description of the architecture and overview can be found in 3GPP Technical Specification TS 23.002 ‘Network Architecture’ which is included in the present application by reference in its entirety. Other types of cellular telecommunication system can alternatively or additionally be used, e.g. a 5G cellular telecommunication system.

The lower branch of FIG. 6 represents a GSM/GPRS or UMTS network.

For a GSM/GPRS network, a radio access network (RAN) system 520 comprises a plurality of nodes, including base stations (combination of a BSC and a BTS), not shown individually in FIG. 6. The core network system comprises a Gateway GPRS Support Node 522 (GGSN), a Serving GPRS Support Node 521 (SGSN, for GPRS) or Mobile Switching Centre (MSC, for GSM, not shown in FIG. 6) and a Home Location Register 523 (HLR). The HLR 523 contains subscription information for user devices 501, e.g. mobile stations MS.

For a UMTS radio access network (UTRAN), the radio access network system 520 also comprises a Radio Network Controller (RNC) connected to a plurality of base stations (NodeBs), also not shown individually in FIG. 6. In the core network system, the GGSN 522 and the SGSN 521/MSC are connected to the HLR 523 that contains subscription information of the user devices 501, e.g. user equipment UE.

The upper branch of the telecommunications system in FIG. 6 represents a next generation network, commonly indicated as Long Term Evolution (LTE) system or Evolved Packet System (EPS).

The radio access network system 510 (E-UTRAN), comprises base stations (evolved NodeBs, eNodeBs or eNBs), not shown individually in FIG. 6, providing cellular wireless access for a user device 501, e.g. user equipment UE. The core network system comprises a PDN Gateway (P-GW) 514 and a Serving Gateway 512 (S-GW). The E-UTRAN 510 of the EPS is connected to the S-GW 512 via a packet network. The S-GW 512 is connected to a Home Subscriber Server HSS 513 and a Mobility Management Entity MME 511 for signalling purposes. The HSS 513 includes a subscription profile repository SPR for user devices 501.

For GPRS, UMTS and LTE systems, the core network system is generally connected to a further packet network 502, e.g. the Internet.

Further information of the general architecture of an EPS network can be found in 3GPP Technical Specification TS 23.401 ‘GPRS enhancements for Evolved Universal Terrestrial Radio Access Network (E-UTRAN) access’.

FIG. 7 depicts a block diagram illustrating an exemplary data processing system that may perform the methods as described with reference to FIGS. 4 and 5.

As shown in FIG. 7, the data processing system 600 may include at least one processor 602 coupled to memory elements 604 through a system bus 606. As such, the data processing system may store program code within memory elements 604. Further, the processor 602 may execute the program code accessed from the memory elements 604 via a system bus 606. In one aspect, the data processing system may be implemented as a computer that is suitable for storing and/or executing program code. It should be appreciated, however, that the data processing system 600 may be implemented in the form of any system including a processor and a memory that is capable of performing the functions described within this specification.

The memory elements 604 may include one or more physical memory devices such as, for example, local memory 608 and one or more bulk storage devices 610. The local memory may refer to random access memory or other non-persistent memory device(s) generally used during actual execution of the program code. A bulk storage device may be implemented as a hard drive or other persistent data storage device. The processing system 600 may also include one or more cache memories (not shown) that provide temporary storage of at least some program code in order to reduce the number of times program code must be retrieved from the bulk storage device 610 during execution.

Input/output (I/O) devices depicted as an input device 612 and an output device 614 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 7 with a dashed line surrounding the input device 612 and the output device 614). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 616 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 600, and a data transmitter for transmitting data from the data processing system 600 to said systems, devices and/or networks. Modems, cable modems, and Ethernet cards are examples of different types of network adapter that may be used with the data processing system 600.

As pictured in FIG. 7, the memory elements 604 may store an application 618. In various embodiments, the application 618 may be stored in the local memory 608, the one or more bulk storage devices 610, or separate from the local memory and the bulk storage devices. It should be appreciated that the data processing system 600 may further execute an operating system (not shown in FIG. 7) that can facilitate execution of the application 618. The application 618, being implemented in the form of executable program code, can be executed by the data processing system 600, e.g., by the processor 602. Responsive to executing the application, the data processing system 600 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 602 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for determining cell groups in a mobile communication network, comprising at least one processor configured to:
determine a plurality of sets of cell groups, each set comprising a plurality of cell groups, each of said cell groups comprising at least one cell, and at least one of said cell groups of each set comprising a plurality of cells,
associate each set of said plurality of sets of cell groups to at least one of a plurality of successive time periods,
for each of said plurality of successive time periods, associate each of a plurality of mobile devices to one cell group of said set associated with said time period,
arrange transmission of one or more messages to said plurality of mobile devices, said one or more messages instructing each mobile device to participate during each of said plurality of successive time periods in a cell group associated with said each mobile device in connection with said time period,
control a plurality of base stations associated with cells of said plurality of sets of cell groups to form, during each of said plurality of successive time periods, said cell groups of said set of cell groups associated with said time period,
determine and/or receive a plurality of sets of performance indicator values relating to actual transmissions between said plurality of mobile devices and said plurality of base stations during said plurality of successive time periods, each set of said plurality of sets of performance indicator values relating to a different one of said plurality of successive time periods, and
select one set of said plurality of sets of cell groups based on said determined plurality of sets of performance indicator values.

2. A system as claimed in claim 1, wherein said at least one processor is configured to:
arrange transmission of one or more further messages to said plurality of mobile devices, said further messages instructing said mobile devices to participate in a cell group of said selected set of said plurality of sets of cell groups, and
control said base stations to form said cell groups of said selected set of said plurality of sets of cell groups.

3. A system as claimed in claim 1, wherein said at least one processor is configured to receive at least some performance indicator values of said plurality of sets of performance indicator values from said plurality of mobile devices.

4. A system as claimed in claim 1, wherein said plurality of sets of performance indicator values comprises one or more performance indicator values representing at least one of throughput, delay and error rate.

5. A system as claimed in claim 1, wherein at least two of said plurality of successive time periods are associated with the same set of said plurality of sets of cell groups.

6. A device for participating in a cell group, comprising:
a communication interface; and
at least one processor configured to use said communication interface to receive one or more messages from a mobile communication network, said one or more messages instructing said device to participate during each of a plurality of successive time periods in a cell group associated with said time period, and configured to perform said instructed participation.

7. A device as claimed in claim 6, wherein said at least one processor is configured to determine a plurality of sets of performance indicator values relating to actual transmissions between at least one mobile device and said mobile communication network during said plurality of successive time periods, each set of said plurality of sets of performance indicator values relating to a different one of said plurality of successive time periods, and to use said communication interface to transmit said plurality of sets of performance indicator values to said mobile communication network.

8. A device as claimed in claim 7, wherein said plurality of sets of performance indicator values comprises one or more performance indicator values representing at least one of throughput, delay and error rate.

9. A method of determining cell groups in a mobile communication network, comprising:
determining a plurality of sets of cell groups, each set comprising a plurality of cell groups, each of said cell groups comprising at least one cell, and at least one of said cell groups of each set comprising a plurality of cells;
associating each set of said plurality of sets of cell groups to at least one of a plurality of successive time periods;
for each of said plurality of successive time periods, associating each of a plurality of mobile devices to one cell group of said set associated with said time period;
arranging transmission of one or more messages to said plurality of mobile devices, said one or more messages instructing each mobile device to participate during each of said plurality of successive time periods in a cell group associated with said each mobile device in connection with said time period;
controlling a plurality of base stations associated with cells of said plurality of sets of cell groups to form, during each of said plurality of successive time periods, said cell groups of said set of cell groups associated with said time period;
determining and/or receiving a plurality of sets of performance indicator values relating to actual transmissions between said plurality of mobile devices and said plurality of base stations during said plurality of successive time periods, each set of said plurality of sets of performance indicator values relating to a different one of said plurality of successive time periods; and
selecting one set of said plurality of sets of cell groups based on said determined plurality of sets of performance indicator values.

10. A method of participating in a cell group, comprising:
receiving one or more messages from a mobile communication network at a device, said one or more messages instructing said device to participate during each of a plurality of successive time periods in a cell group associated with said time period; and
performing said instructed participation at said device.

11. A computer program or suite of computer programs comprising at least one software code portion or a computer program product storing at least one software code portion, the software code portion, when run on a computer system, being configured for performing the method of claim 9.
